(19) United States
(12) Patent Application Publication
(10) Pub. No.: US 2019/0350334 A1
(43) Pub. Date: Nov. 21, 2019

(54) HAIR STYLING APPARATUS WITH SENSOR SYSTEM FOR TEMPERATURE ADJUSTMENTS AND PREVENTING OVERDRYING

(71) Applicant: James G Montagnino, Saint Charles, IL (US)

(72) Inventor: James G Montagnino, Saint Charles, IL (US)

(21) Appl. No.: 15/980,705

(22) Filed: May 15, 2018

(51) Int. Cl. A45D 20/12; A45D 1/28; A45D 1/04; G05B 11/01

(52) U.S. Cl. CPC A45D 20/12; A45D 1/28; A45D 2200/207; G05B 11/01; A45D 1/04

(57) ABSTRACT

Embodiments of the present invention provide systems and methods for preventing over heating by a hair drying and styling tool. The tool is equipped with a mist generator and heat sensing system. The heat sensing system based on radiometry includes a radiometric thermal sensor that senses the infrared radiations reflected from the hair being heated and communicates the level of the infrared radiations to a controlling means. When the level of the infrared radiations exceeds a predetermined level, the controlling means, further, controls the output of the hair drying tool and the mist generator. The controlling means can lower the output temperature of the hair styling tool or activates the mist generator to spray an ultra fine stream of cool water mist on hair. Thus, the temperature and moisture levels of hair are maintained, and hence, preventing damages caused by overheating to the hair and scalp.

### FIELD OF INVENTION

The present invention is generally related to electric heating hair styling appliances, and more particularly related to hair styling appliances equipped with a mist generator and a sensor system for preventing over drying and automatically adjusting temperature of heat air stream.

### BACKGROUND

Various appliances and methods have been evolved in technologies to dry wet hair and also to adapt hair styling techniques. Few of the examples are blow dryers, electric dryers, styling tools such as flat irons (straighteners) or curling rods and others. While using these appliances, a general and most occurring problem is over dried and damaged hair from over drying and continuous use of these appliances. Further, the rate of drying hair is proportional to the temperature of the hair. When hair is wet, it absorbs the heat of the dryer air stream and acts as a shield for scalp. As the water dries, the temperature of hair increases and some of the heated air reaches scalp, resulting in pain and damage.

Addressing to the above mentioned problems, the hair drying appliances are designed with some automatic means to adjust the temperature of the heated air stream that would allow for rapid drying and also avoid over drying and damaging hair and scalp. One method can be when a user moves the hand held dryer farther away from the hair, thus dissipating heat of the airstream from the dryer to surrounding air. This leads to increase in time for drying hair; hence it can become a cumbersome, time taking and unsatisfactory method. Also, drying the hair this way may result in uneven drying of hair, making it difficult for the user to make the temperature adjustments, without suffering over dried hair and scalp pain in at least some areas of the head. Another method may again be implemented by the user, when the user may intermittently switches OFF the dryer or the heating appliance to avoid over dried hair and scalp pain. Alternatively, the user may lower the temperature settings also. But again, this way is time taking and results in uneven drying. Additionally, the user needs to be attentive for checking the hair temperature by any pain sensation. Hence, the process becomes inefficient. Therefore, the issues still remains the same.

Technologies have evolved to overcome the issues with over drying of hair from the heating appliances. A Patent Application Number CN202959232U discloses a multifunctional hair dryer which comprises a hair dryer body and a handle connected with the hair dryer body. A control switch and an atomization air valve are arranged on the handle. An ultrasonic nebulizer is arranged inside the handle. A mist is sprayed from the ultrasonic nebulizer to hair for nursing and modeling. However, the patent application fails to disclose any means to control the operation of the hair dryer by automatically detecting the temperature reached of hair. Therefore, the hair dryer may result in over drying.

A US Patent Application numbered US20170013931A1 describes discloses an ultrasonic fog treatment and hair straightener. Suitably, the hair straightener is provided by an electric device comprising a heating mechanism and restorative or spa means, including storage boxes and atomization means. The restorative and spa means for hair styling and spa effectively alleviate hair damage caused by heating and enhance the straightening effect of the hair. The ultrasonic mist generator produces mist/fog targeting hair that is enclosed between the metal plates of the straightener. However, the patent application fails to describer any automatic means to prevent over drying of hair and pain scalp.

Although various technologies have disclosed use of mist spraying on hair while styling or drying hair, but none of them discloses a system and a method for preventing over drying of hair by automatically controlling the operation of the heating appliance by lowering the temperature of the heated airstream.

Therefore, there exists a need to provide a system and a method for hair styling and drying that automatically adjusting the temperature of the airstream and hence, the operation of the hair heating appliance to prevent over drying. Further, there is also a need to provide a means to maintain the moisture level of hair to avoid over drying.

### SUMMARY OF THE INVENTION

Hence, it is an objective of the present invention to provide an apparatus for hair drying and styling that comprises a hair styling appliance in combination with a mist/fog generator. In an embodiment, the mist/fog generator incorporates ultrasonic production and application of mist.

It is further an objective of the present invention to provide a uniform ultra fine water/moisture particle size for uniform deposition of the mist at hair via the hair styling appliance.

It is also an objective of the present invention to provide a sensor system in the hair drying apparatus that detects temperature of heated airstream and hence, controls the operation of the hair drying apparatus by lowering the temperature; and also controls the operation of the mist generator.

It is a further objective of the present invention to activate mist/fog application manually during styling or independently as required by a stylist/user.

The foregoing and other objects, features and advantages of the invention will be apparent from the following more particular descriptions of exemplary embodiments of the invention.

### BRIEF DESCRIPTION OF THE EMBODIMENTS

The manner in which these objectives and other desirable characteristics can be obtained is explained in the following description and attached figures in which:

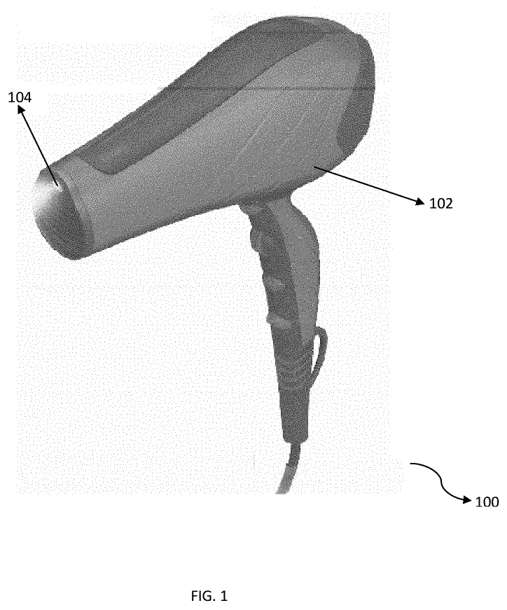

FIG. 1 shows a perspective view of a hair dryer, operating as a hair styling tool, in conjunction with a mist generator, in accordance with an embodiment of the present invention;

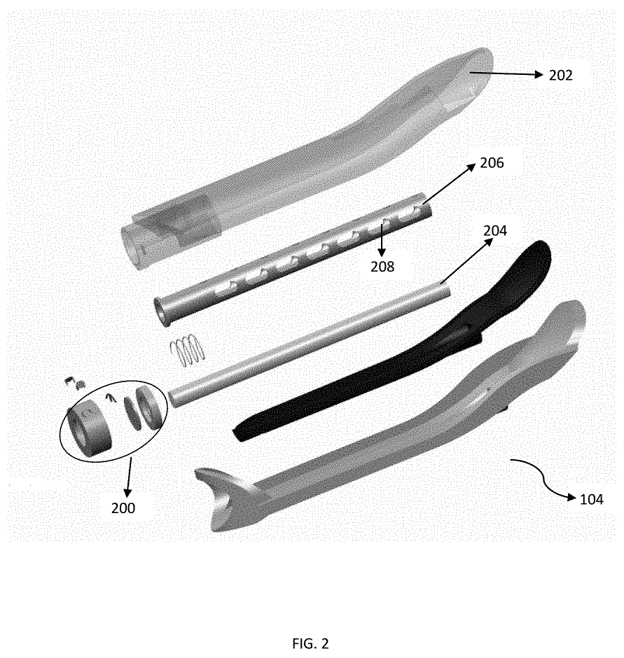

FIG. 2 shows an exploded view of the mist generator, in accordance with an embodiment of the present invention;

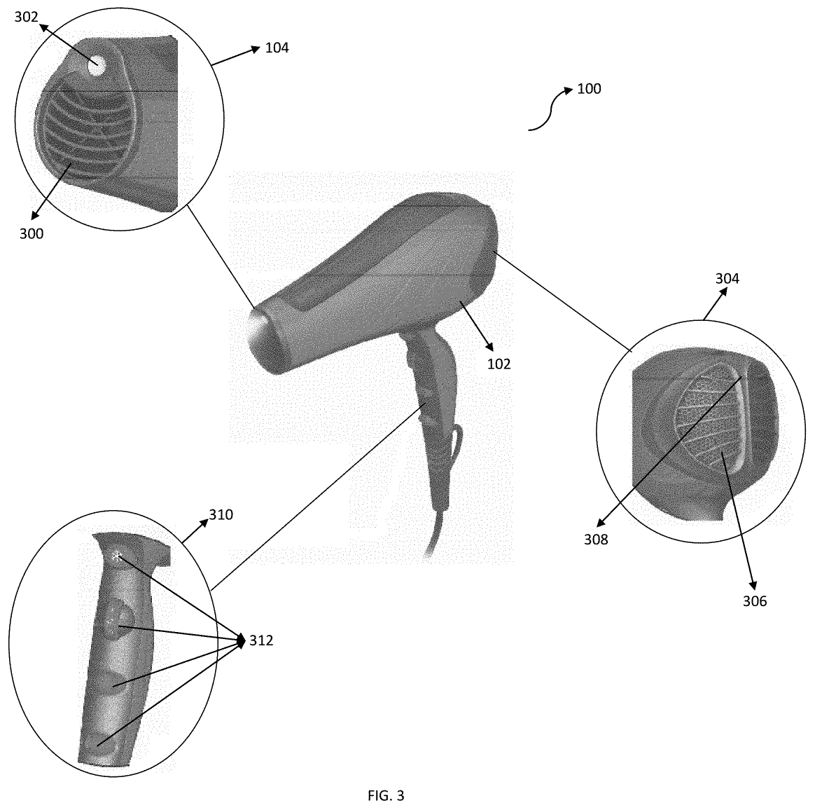

FIG. 3 shows enlarged views of front, rear and handle portions of the apparatus, in accordance with an embodiment of the present invention;

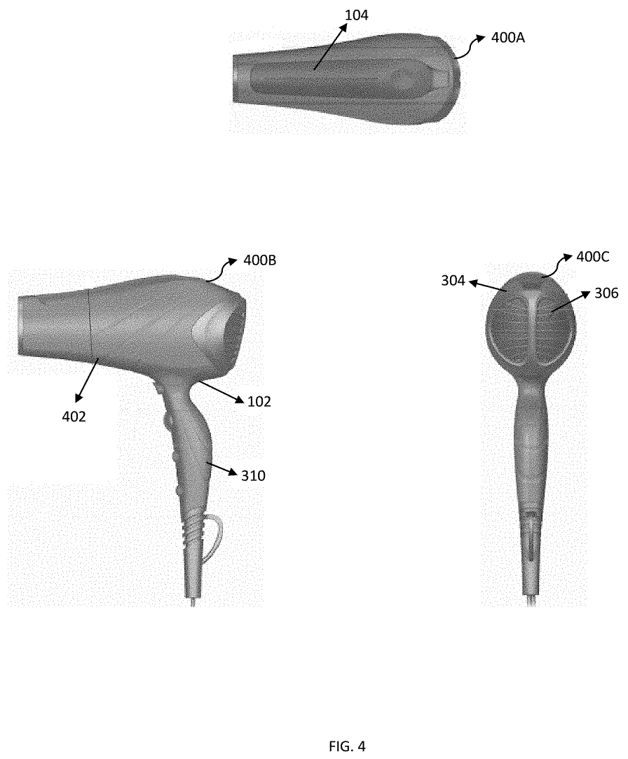

FIG. 4 shows top view, side view and rear view of the apparatus, in accordance with an embodiment of the present invention;

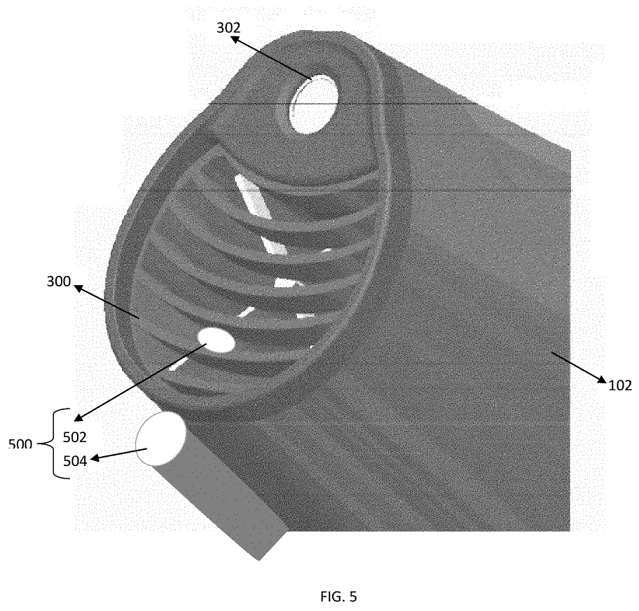

FIG. 5 shows a heat sensing system installed in the hair dryer, in accordance with an embodiment of the present invention; and

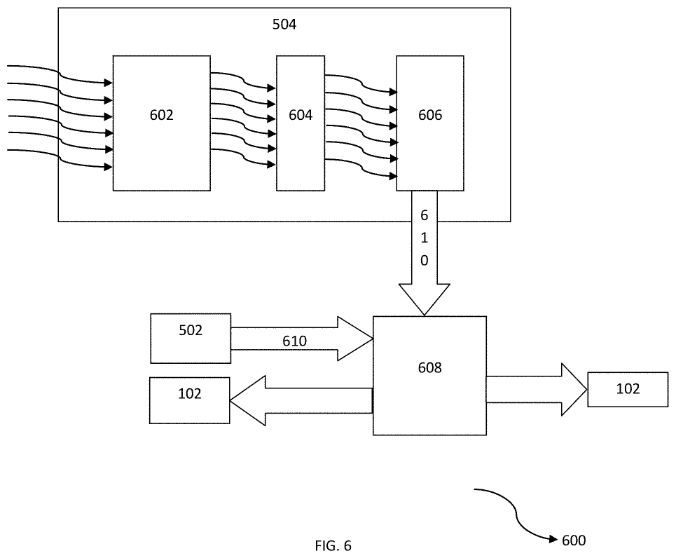

FIG. 6 shows an exemplary view of operation flow of the heat sensing system and its components, in accordance with an embodiment of the present invention.

### DETAILED DESCRIPTION

This patent describes the subject matter for patenting with specificity to meet statutory requirements. However, the description itself is not intended to limit the scope of this patent. The principles described herein may be embodied in many different forms, while being used individually or jointly.

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The present invention discloses an apparatus for hair drying and styling including a heating hair styling tool, a mist generator and a heat sensing device. The apparatus provides heated airstream, exited from the hair styling tool, for drying and styling wet hair. The styling tool operates essentially as a normal heated appliance used for styling and drying hair. To prevent over drying of hair and pain in scalp due to heated airstream, the apparatus employs the mist generator and the heat sensing device.

The mist generator applies a fine vapor mist parallel or adjacent to the heated area of the tool. The mist generator produces and sprays an ultra fine and light stream of ultrasonic cool mist, which replaces the moisture lost by hair while being exposed to the heated airstream and hence prevents over drying. Further, the heat sensing device detects the temperature of the hair reached by sensing the heat reflected by the hair. Depending on the temperature, the heat sensing device automatically controls the operation of the hair styling tool by lowering the temperature of the airstream.

The apparatus includes an ultrasonic vapor mist condition feature provided by the ultrasonic mist generator that emits a fine vapor mist based on an operation setting selected depending on one or more predetermined criteria for hair. The predetermined criteria may include and is not limited to hair type, maximum temperature, optimum moisture level, time for heating before cuticle damage and others. The mist generator sprays a fine and light vapor mist adjacent or parallel to the exit area of the heated airstream from the hair styling tool. Further, the mist generator may be operated either individually or along with the hair styling tool. Furthermore, the mist generator may be operated either manually or automatically. The automatic operation of the mist generator depends on heat and moisture levels reached by the hair. It may also depend on other factors such as operating time of the hair styling tool, and others.

The mist generator is automatically switched ON by the heat sensing device. The heat sensing device detects the heat levels reflected by the hair while being dried by the hair styling tool. Depending on the sensed heat level, the condition of the hair is analyzed. Thereafter, the heat sensing device activates the mist generator, if the heat level of the hair exceeds a predetermined level or the moisture level reduces below a predetermined level. Therefore, applying a fine vapor mist application adjacent to the exit area of the heat airstream, the hair is moistened. Furthermore, the heat sensing device also automatically controls the wattage of the hair styling tool and lowers the wattage to prevent overheating. Additionally, the spraying of vapor mist is shut off when an appropriate hair temperature is reached. In an embodiment, a user may also select an override to eliminate the vapor mist if desired.

FIG. 1 shows a perspective view of a hair dryer, operating as a hair styling tool, in conjunction with a mist generator, in accordance with an embodiment of the present invention. As seen in FIG. 1, the apparatus 100 includes the hair dryer 102 and the mist generator 104. The hair dryer 102 acts as a hair styling tool in FIG. 1 that operates essentially as a normal heated appliance using either standard heating technologies or ion generators in combination with the heater. It may be appreciated by a person ordinarily skilled in the art that the heating appliances of the hair styling tool may be of different types, such as standard Resistance Wire, Positive Temperature Coefficient (PTC) or Ceramic heater technologies and the like, without departing from the scope and meaning of the present invention. Preferably a ceramic heater since it is not affected by the mist generator that is outboard or adjacent to the heating portion of the styling tool. Examples of the hair styling tools that may be employed in the present invention may include and are not limited to flat irons (straighteners), or curling irons (various shapes/styles—employing spring clamps, marcel clamps or no clamp), or electric hair dryers and the like.

The mist generator 104 provides and applies ultra fine mist uniformly on the hair that is targeted by the hair styling tool. The mist generator 104 can be activated as required by the user/stylist to provide conditioning moisture that assists in setting hair curls, waves or styling shapes or straightening as desired. The function of the mist generator is to produce ultra fine particles of mist or fog to spray or apply the mist at the hair in order to provide very uniform surface moisture and has the added benefit of reducing hair damage caused by over drying of hair.

In an embodiment of the present invention, the mist generator 104 is an ultrasonic mist generator. The ultrasonic mist generator 104 is able to function independently of the hair styling tool with which it is incorporated or may work in conjunction with the styling tool as required by the stylist. Such user control may be provided in the apparatus 100 where the user may be able to operate the mist generator independently or in conjunction with the styling tool. Further, the ultrasonic mist generator 104 provides a controlled moisture delivery of ultra fine particles of cool sonic mist via the hair styling tool. The mist generator 104 is explained in detail in the following figure.

FIG. 2 shows an exploded view of the mist generator, in accordance with an embodiment of the present invention. The ultrasonic mist generator 104 comprises a piezoelectric-based ultrasonic transducer 200; a fixed or removable water/fluid tank 202; a wick tube 204; a manifold 206 including a spray nozzle with uniformly placed holes 208; and a water supply system in form of a valve (not shown in the FIG. 2) to allow water entry to the ultrasonic transducer 200. The present invention adopts the ultrasonic transducer 200 in conjunction with a wick 204 water transfer similar to ultrasonic humidifiers or health related nebulizers. The transducer 200 does not need any fin to blow the mist out. The mist generated can be ejected directly from the exit area of the transducer 200.

The water supply is executed via a cylindrical shaped wick tube 204 that absorbs water from the water tank 202 and transfers to the transducer 200. The transducer 200, thereafter, produces ultra fine and light vapor mist. The manifold 206 has uniformly spaced vents or holes 208 to provide uniform application of water mist on the hair. The manifold 206 with the holes 208 is designed in such a way to have uniform and ultra fine mist particle size for uniform deposition at hair via the hair dryer 102. It may be appreciated by a person ordinarily skilled in the art that the design of the manifold may be varied depending on the hair styling tool type and the requirements, without departing from the meaning and scope of the present invention. Such as, the holes may be of any shapes and sizes depending upon the requirements. For example, the holes may be round or circular in shape, with equal diameter and size, or gradually increasing or decreasing in sizes along the length of the manifold 206. For uniform and even application of water mist on the hair, the placement, size and shape of the holes/spray nozzle/nebulizer plays an important role.

Further, the piezoelectric based transducer or mister 200 provides a means for creating large amounts of very fine mist that allows for maximum absorption of the mist in hair cuticles and roots. The mist generator 104 produces very small drops of size approximately less than 10 μm. Such fine size of the drops enable the mist to behave more like a gas than liquid and hence, allows drops to remain airborne and diffuse through clutter. This characterization of the mist works efficiently with the heat airstream blown out of the hair dryer 102 to provide uniform application of the mist on hair and so, uniformly moisturizing the hair throughout the hair shaft and allowing deep penetration of small and light mist in the body and roots of hair. Unlike ion generated steam or water particles, the water partial size in the present invention is much finer that it increases penetration and absorption into the hair. The mist generator 104 sprays the vapor mist either parallel or intersecting to the exit area of the airstream from the hair dryer 102, just forward of protective exit grille of the hair dryer 102.

Furthermore, the tank 202 may store a fluid that needs to be sprayed on hair. In a preferred embodiment, the tank stores water. In another embodiment, the tank 202 may store a light weight hair conditioner, an aromatic fluid/oil, colognes, styling lotions, or any other desired light weight fluid for hair. The tank 202 may be inserted into or attached to the body of the hair dryer 102. The water supply system, preferably a pump bellow using siphon valves to supply water to the ultrasonic transducer 200. While operation of the hair dryer 102, the exit airstream causes hair movement, while providing a delivery vehicle to carry moisture deep into and all through the head of hair.

The present design in the invention allows for a flexible location and placement of the ultrasonic transducer 200 with respect to the hair dryer 102. Also, the water tank may be attached anywhere suitable for the hair dryer, able to supply water to the transducer 200. Further, in an embodiment, the vapor/moisture output can be from 5-8 ounces/hour, therefore a small water tank would be sufficient. Also, the tank size should be relative to the size of the hair dryer.

The combination of the mist generator 104 with the hair dryer 102 in a single apparatus 100 eliminates the need for a separate mister bottle.

FIG. 3 shows enlarged views of front, rear and handle portions of the apparatus, in accordance with an embodiment of the present invention. The front portion of the apparatus 100 includes exit area of the hair dryer 102 and exit area of the ultrasonic mist generator 104. The exit area or outlet of the hair dryer 102 has an exit grille 300, through which heated airstream is blown out. Further, since the mist generator 104 is attached adjacent to the hair dryer 102, the outlet or exit area of the mist generator 104 is also adjacent to the exit area of the hair dryer 102. As seen from the FIG. 3, the outlet of the hair dryer 102 is below the outlet of the mist generator 104. The outlet of the mist generator 104 has an opening 302 through which cool sonic vapor mist is sprayed out. Adapting to the placement of the outlet of the mist generator above the outlet of the hair dryer 102, the ultra fine and light mist when sprayed out of the opening 302, is carried to the hair along with the heated airstream blown out of the grille 300 which is just below the opening 302.

Further, the rear portion of the apparatus 100 shows the rear inlet 304 of the hair dryer 102 including grille 306. A preferable design of the hair dryer 102 has increased size of the rear inlet 304 and reduced width of centre rib 308 to allow more air to flow into the hair dryer 102 with less turbulence.

The hair dryer 102 also has a handle portion 310 that includes controls 312 to control the operation of the hair dryer 102 and the mist generator 104. The controlling actions may include and is not limited to switch ON/OFF the hair dryer and the mist generator, control the temperature of the hot air stream blown out from the hair dryer, the mist amount to be sprayed, speed of blowing hot airstream and spraying mist, and the like. Further, it may be appreciated by a person skilled in the art that the controls 312 may be in different forms, such as switches, gauged scrolling buttons, touch input, and the like without departing from the meaning and scope of the present invention. Furthermore, the handle 310 may also include a display unit to view the operating settings of the hair dryer 102 and the mist generator 104. The display may include and is not limited to LED lights, touch display, LCD display, or markers, and the like. The operating settings may include and are not limited to ON/OFF condition of the hair dryer and the mist generator, temperature, speed, mist amount settings, cold shot setting, and the like.

FIG. 4 shows top view, side view and rear view of the apparatus including the hair dryer and the mist generator, in accordance with an embodiment of the present invention. The top view 400A shows the mist generator 104 located at the top of the hair dryer 102. The side view 400B shows, the hair dryer 102 with its barrel 402 and handle 310. The barrel is tapered in shape to make it look sleeker. The rear view 400C shows the rear inlet 304 of the hair dryer 102 including grille 306.

FIG. 5 shows a heat sensing system installed in the hair dryer, in accordance with an embodiment of the present invention. The heat sensing system 500 has a set of sensors that detects the heat levels of the hair reached during drying and accordingly controls the operations of the hair dryer 102 and the mist generator 104. As the heat level or temperature of the hair exceeds a predetermined level, the heat sensing system 500 may automatically take a number of reflex operating actions to prevent any damage to hair and scalp, such as over drying, reduced moisture level of hair and pain in scalp. The number of reflex operating actions may include activating the mist generator 104 to spray cool vapor mist, lowering the temperature of the hot airstream blown out from the hair dryer 102, switching off the hair dryer 102 for a predetermined time, lowering the speed of the hot airstream, overall lowering the wattage of the hair dryer 102 to reduce heat and speed of the airstream, and the like. In this way, the heat sensing system 500 equipped in the hair dryer 102 prevents damages caused to the hair and scalp due to over drying and heat. In an embodiment, the heat sensing system 500 triggers the reflex operating actions based on the detected levels of temperature and moisture of hair. Therefore, the heat sensing system 500 provides an automatic mode to the hair apparatus 100 where it triggers the reflex operating actions depending on the condition of hair.

The heat sensing system 500 is a radiometry based system that measures electromagnetic radiations and is located inside the body of the hair dryer 102 close to the exit nozzle or outlet for hot airstream. The heat sensing system 500 senses the infrared radiations reflected back from the hair being heated and triggers any of the required reflex operating actions based on the detected level of infrared radiations. A sensor feedback circuit of the heat sensing system 500 controls the reflex operating actions.

In an embodiment, the heat sensing system 500 includes an output temperature sensor 502 that is located inside the bottom quadrant of the outlet grille 300; and a reflection sensor device 504 that is located into the concave of the outer diameter of the exit nozzle adjacent to the its exterior. The output temperature sensor 502 senses the temperature of hot airstream exiting from the hair dryer 102. While the reflection sensor device 504 captures and measures the temperature of hot air reflected from hair being dried. The working and components of the heat sensing system 500 is explained in details in conjunction with the following figure.

The heat sensing system 500, with the output temperature sensor 502 and the reflection sensor 504, work in one or more operating modes. In an embodiment, the heat sensing system 500 is working in automatic mode. This means that the sensors 502 and 504 are automatically triggered ON, for example as the hair dryer 102 is switched ON. In another embodiment, the heat sensing system 500 is manually switched ON by the user. Therefore, the handle portion of the hair dryer 102 has controls to operate the heat sensing system 100. In a further embodiment, the heat sensing system 500 works in automatic mode in conjunction with the automatic mist generator 104 mode. In another embodiment, the heat sensing system 500 works in automatic mode without engaging the mist generator 104.

FIG. 6 shows an exemplary view of operation flow of the heat sensing system and its components, in accordance with an embodiment of the present invention. Since the heat sensing system 500 is employed near the exit nozzle of the hair dryer 102, thus the heat sensing system 500 is aimed at an area of hair where the hot airstream from the dryer 102 is targeted. As mentioned above, the heat sensing system 500 includes a reflection sensor device 504 that picks up the infrared radiations reflected from the heated hair. According to the operation flow 600 shown in the FIG. 6, the reflection sensor device 504 includes a mirror 602 that picks up and reflects the infrared radiation reflected from the hair while being heated. Thereafter, the mirror 602 reflects the infrared radiation through a spectrally selective window 604 to a radiometric thermal sensor 606. The thermal sensor 606 is placed in the focal plane of the mirror 602.

Further, the thermal sensor 606 is connected to a controlling means 608 that is equipped in the hair dryer 102. The controlling means 608 is an electronic unit that triggers any of the desired reflex operating actions based on the amount of infrared radiations detected by the reflection sensor device 504. For example, the controlling means 608 may control the output wattage of the hair dryer 102 and hence, the temperature of the hot airstream. Resultantly, the temperature of the target hair is controlled. The controlling means 608 works in conjunction with the output temperature sensor 502 and receives feedback from the output temperature sensor 502 about the temperature of the exiting hot airstream from the dryer 102. In this way, the controlling means 608 is able to control the temperature of the airstream, and hence the temperature of the targeted hair.

Additionally, the controlling means 608 may activate the mist generator 104 to spray cool sonic mist on hair, hence maintaining the temperature and moisture of the target hair. The heat sensing system 500 has a sensor feedback circuit 610 that connects the components of the heat sensing system with the controlling means 608 and allows communication between them. The controlling means 608 receives temperature feedback from the reflection sensor device 504 and the output temperature sensor 502 via the sensor feedback circuit 610, and in turn control the operations of dryer 102 and mist generator 104 based on the feedback circuit 610.

Further, in an embodiment, the controlling means 608 may be selectively adjusted on the predetermined levels of temperature and moisture, so that the hair dries and the temperature of the hair fibers reaches to a point at which the hair contains that predetermined amount of moisture. Thereafter, the heat of the airstream is automatically adjusted and reduced, thus permitting the most efficient drying and preventing over drying of the hair and pain sensation in the scalp. The controlling means 608 prevents the temperature of the scalp to reach a level where the scalp starts paining, such as 50 degrees C.

In a preferred embodiment, the radiometric thermal sensor 606 is a pyro-electric sensor since it has the highest sensitivity and response time. It may be further appreciated by a person skilled in the art that the present apparatus may use various known radiometric infrared sensors available other than pyro-electric sensor, without departing from the meaning and scope of the present invention. The pyro-electric sensor may operate on an AC or DC radiometer.

In an exemplary scenario, to reach maximum efficiency by the apparatus 100, the reflection sensor device 504 reads the temperature of the target hair; for example, say about 0.3×0.8 inches on the head, when the dryer 102 is held about 6 inches away from the head. The reflection sensor device 504 sends the temperature reading to the controlling means 608 that in turn, activates the mist generator 104 to prevent damages from over drying by emitting an ultra fine spray of cool sonic mist on the target hair.

The mist generator 104 of the present invention may be operated in more than one mode. For example, in an embodiment of the present invention, the mist generator 104 is automatically triggered by the reflection sensor 504, as explained above in FIG. 6. Further, in an embodiment the mist generator 104 is manually switched ON as determined by the user. In another embodiment, the mist generator 104 works just constantly when the hair dryer 102 is operating without the sensors (504) being turned ON. In a yet another embodiment, the mist generator 104 is manually activated by pressing a button similar to a cold shot function.

It may be appreciated by a person skilled in the art, that the hair dryer 102 may be designed with various dimensions to have a target area of various sizes and where the dryer may be allowed to be held at various distances from the head, without departing from the meaning and scope of the present invention.

Although the detailed description along with the drawings shows only one embodiment of the present invention disclosing the hair dryer 100, the apparatus of the present invention may be a variety of other hairy styling tools, such as a hair straightener, a curling iron rod, which can be equipped with the mist generator to produce and apply water mist on the hair.

Advantageously, the present invention provides an automatic means to sense the temperature of the hair being dried and controls the operation of the hair drying apparatus to prevent damages caused to the hair and scalp due to overheating.

Since other modifications and changes varied to fit particular operating requirements and environments are apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

Although the invention has been explained in relation to its preferred embodiment, it is to be understood that many other possible modifications and variations can be made without departing from the spirit and scope of the invention as herein described.

As one of ordinary skill in the art may appreciate, the example apparatus and method described herein can be modified. For example, certain modules/elements can be omitted, certain elements can be carried added, and other steps can be added. Although particular embodiments of the invention have been described in detail, it is understood that the invention is not limited correspondingly in scope, but includes all changes, modifications and equivalents coming within the spirit and terms of the claims appended hereto.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is to be claimed is:

1. An apparatus for hair drying and styling, comprising:
a hair styling tool employing a heating mechanism for drying hair;
a mist generator, attached adjacent to the hair styling tool, to produce and spray an ultra fine stream of mist on hair;
a heat sensing system, equipped in the hair styling tool, for automatically detecting temperature levels of hair being heated; and
a controlling means, in communication with the heat sensing device, for automatically controlling the operations of the hair styling tool and the mist generator, depending on the detected temperature level, to prevent overheating of hair, and thus maintaining the temperature level and moisture level of hair.

2. The apparatus as claimed in claim 1, wherein the heat sensing system includes a reflection sensor device that detects infrared radiations reflected from the hair when being heated and sends the detected level of infrared radiations to the controlling means.

3. The apparatus as claimed in claim 1, wherein the controlling means automatically executes a set of reflex operating actions that selectively operates the hair styling tool and the mist generator, depending on the level of the infrared radiations reflected by the hair.

4. The apparatus as claimed in claim 3, wherein the set of reflex operating actions includes activating the mist generator to produce and spray vapor mist; lowering the temperature of the heating mechanism in the hair styling tool, switching off the hair styling tool for a predetermined time, lowering the speed of a hot airstream, overall lowering the wattage of the hair styling tool to reduce heat and speed of the airstream, and the like.

5. The apparatus as claimed in claim 1, wherein the heat sensing system further includes an output temperature sensor, installed near the heating mechanism of the hair styling tool, that detects the temperature of the heating mechanism reached and sends the detected temperature to the controlling means for controlling the temperature when desired.

6. The apparatus as claimed in claim 2, wherein the reflection sensor device further includes a mirror; and a radiometric thermal sensor, where the mirror picks up and reflects the infrared radiations, coming from the hair being heated, to the radiometric thermal sensor through a spectrally selective window.

7. The apparatus as claimed in claim 6, wherein the radiometric thermal sensor is located in the focal plane of the mirror.

8. The apparatus as claimed in claim 6, wherein the radiometric thermal sensor is a pyro-electric thermal sensor either being operated on an AC or DC radiometer.

9. The apparatus as claimed in claim 1, wherein the hair styling tool is a blow hair dryer, or a hair straightener, or a curling rod, or any other suitable hair drying and styling tool with its own heating mechanism depending on the type.

10. The apparatus as claimed in claim 1, wherein the mist generator stores water and produces ultra fine cool water mist.

11. The apparatus as claimed in claim 1, wherein the mist generator stores any light weight hair fluid, such as conditioner, serum, styling lotions, colognes, and the like and produces mist from the light weight fluid.

12. The apparatus as claimed in claim 1, wherein the mist generator operates in any one of operating modes, namely, automatically triggered by the reflection sensor; manually switched ON as determined by the user; and works just constantly when the hair styling tool is operating without the reflection sensor being turned ON.

13. The apparatus as claimed in claim 1, wherein the heat sensing device functions in any one of operating modes, namely, automatic mode; manually switched ON by the user; in automatic mode in conjunction with the automatic mist generator mode; and automatic mode without engaging the mist generator.

14. An automatic control system for preventing overheating by a hair drying and styling tool, the system comprising:
a reflection sensor device, installed in the hair drying tool, for sensing amount of infrared radiations reflected from the hair being heated; and
a controlling means, in communication with the reflection sensor device, for receiving the amount of reflected infrared radiations and automatically triggering a set of reflex operating actions to control the hair drying tool and a mist generator attached adjacent to the hair drying tool, when the amount of reflected infrared radiations exceeds a predetermined level;
where the control system, thus, prevents overheating and maintains temperature and moisture level of the hair being heated.

15. The control system as claimed in claim 14, wherein the set of reflex operating actions includes activating the mist generator to produce and spray vapor mist; lowering the temperature of the heating mechanism in the hair styling tool, switching off the hair styling tool for a predetermined time, lowering the speed of a hot airstream, overall lowering the wattage of the hair styling tool to reduce heat and speed of the airstream, and the like.

16. The control system as claimed in claim 14, wherein the controlling means also triggers the set of reflex operating actions when amount of moisture level of hair lowers a predetermined level.

17. The control system as claimed in claim 14, wherein the reflection sensor device includes a mirror; and a radiometric thermal sensor, where the mirror picks up and reflects the infrared radiations, coming from the hair being heated, to the radiometric thermal sensor through a spectrally selective window.

18. The control system as claimed in claim 14, wherein the controlling means communicates with an output temperature sensor installed near a heating mechanism of the hair drying tool to control functioning of the heating mechanism, where the output temperature sensor senses and communicates the temperature of the heating mechanism to the controlling means.

19. The control system as claimed in claim 14, wherein the hair drying tool is a blow hair dryer, or a hair straightener, or a curling rod, or any other suitable hair drying and styling tool with its own heating mechanism depending on the type.

20. A method to prevent overheating by a hair drying and styling tool, the method comprising:
sensing amounts of infrared radiation reflected by the hair being heated, by a reflection sensor device;
communicating the amount of reflected infrared radiation to a controlling means from the reflection sensor device;
automatically triggering, by the controlling means, a set of reflex operating actions to control the hair drying tool and a mist generator located adjacent to the hair styling tool, when the amount of infrared radiations exceeds a predetermined level; and
wherein the method prevents overheating and maintains temperature and moisture level of hair being heated.

21. The method as claimed in claim 20, the set of reflex operating actions includes activating the mist generator to produce and spray vapor mist; lowering the temperature of the heating mechanism in the hair styling tool, switching off the hair styling tool for a predetermined time, lowering the speed of a hot airstream, overall lowering the wattage of the hair styling tool to reduce heat and speed of the airstream, and the like.

22. The method as claimed in claim 20, wherein the reflection sensor device includes a mirror; and a radiometric thermal sensor, where the mirror picks up and reflects the infrared radiations, coming from the hair being heated, to the radiometric thermal sensor through a spectrally selective window.
